(19) United States
(12) Patent Application Publication
(10) Pub. No.: US 2012/0109700 A1
(43) Pub. Date: May 3, 2012

(54) Payroll System Optimization

(75) Inventors: Collin COOK, Eagan, MN (US); Thad HELLMAN, Inver Grove Heights, MN (US); Kristine ARNESON, Minneapolis, MN (US); Kevin NOONAN, St. Paul, MN (US)

(73) Assignee: TARGET BRANDS, INC., Minneapolis, MN (US)

(21) Appl. No.: 12/917,119

(22) Filed: Nov. 1, 2010

(51) Int. Cl. G06Q 10/00

(52) U.S. Cl. 705/7.13

(57) ABSTRACT

In one preferred implementation, a business rules engine optimizes staffing decisions by accepting as inputs top-down constraint as well as bottom-up constraint rules to dynamically determine short to medium term optimal staffing patterns. The business rules engine of this embodiment optionally utilizes a Holt-Winters algorithm which factors in both seasonal and annualized trend information. In certain embodiments, the business rules engine is able to more accurately estimate necessary minimum staffing based on business constraints at both the strategic and operations levels. For instance, strategic (top-down) factors may include intentional overstaffing of stores during certain time periods or in certain key geographic regions, sales forecasts, aggregate margin enhancement, etc. Operational (bottom-up) factors can, in selected embodiments, include time-to-unload, time-to-stock, product throughput and related factors.

### BACKGROUND

Certain retail enterprises have multiple store locations, management teams that collect data across the multiple store locations, and planning teams that use this data to develop strategies for the future of the retail chain. Data created and used by these teams and store locations is often organized by an enterprise software system that ties the data together and provides functionality to the enterprise users.

Staffing is assigned to retail stores in order to facilitate the operations of the retail store. The staffing is assigned to workflow drivers and the completion of the workflow driver activities is monitored and recorded. Some stores are organized into a peer group and staffing resources are assigned to each store in the peer group.

Exponential smoothing is a technique that is applied to a set of measurements such as time series data. The exponential smoothing generates information that generalizes the data or forecasts future measurements. The Holt-Winters algorithm is an exponential smoothing algorithm that considers recentness, trend, and fluctuations.

### SUMMARY

In one preferred implementation, a business rules engine optimizes staffing decisions by accepting as inputs top-down constraints as well as bottom-up workload requirement rules to dynamically determine short to medium term optimal staffing patterns. The business rules engine of this embodiment optionally utilizes a Holt-Winters algorithm which factors in both seasonal and annualized trend information. In certain embodiments, the business rules engine is able to more accurately estimate necessary minimum staffing based on business constraints at both the strategic and operation levels. For instance, strategic (top-down) factors may include intentional overstaffing of stores during certain time period or in certain key geographic regions, sales forecasts, aggregate margin enhancement, etc. Operational (bottom-up) factors can, in selected embodiments, include time-to-unload, time-to-stock, product throughput and related factors. In preferred implementations, operational factors include some of the following workload drivers: pulls, items per pull, back stows, signs, trailers, abandons, price changes, sales mix, and transition hours. Preferred implementations also include forecast drivers such as weekly sales history, ad mapping, cluster model data, and mid-month guidance threshold.

In a further example, an enterprise software system records and manages data in a corporate retail environment. In this example, data recorded at remote stores is transmitted to a multi-store staffing calculator. The multi-store staffing calculator, for example, generates projected staffing levels for each store.

The details of one or more implementations are set forth in the accompanying drawings and description below. Other features, objects, and advantages will be apparent from the description and drawings, and from the claims.

### DESCRIPTION OF DRAWINGS

FIG. 1 shows an example system for generating staffing levels for retail stores.

FIG. 2 is a flowchart showing an example process for allocating staffing levels to stores and workcenters.

FIG. 3 is a flowchart showing an example process for assigning prioritization levels.

FIG. 4 is a chart of an example prioritization scheme.

FIG. 5 is a swimlane diagram showing an example process for assigning staffing levels.

FIG. 6 is a block diagram of a computing system optionally used in connection with computer-implemented methods described in this document.

Like reference symbols in various drawing indicate like elements.

### DETAILED DESCRIPTION OF ILLUSTRATIVE IMPLEMENTATIONS

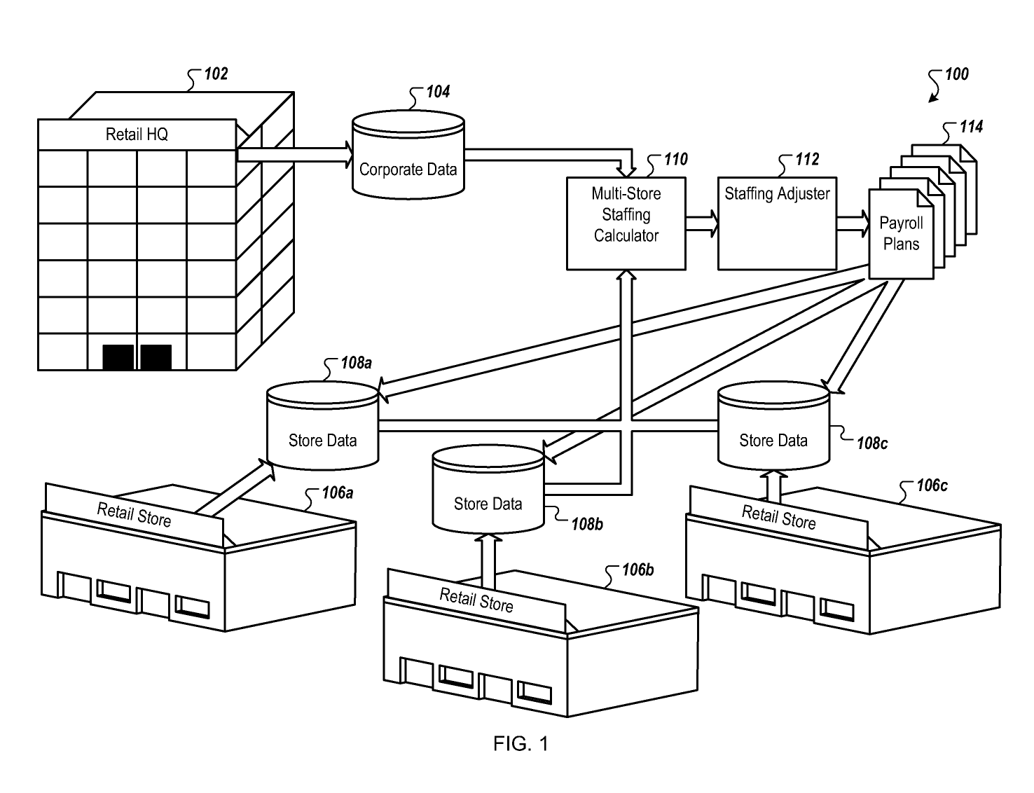

FIG. 1 shows an example system 100 for generating staffing levels for retail stores. In the system 100, a multi-store staffing calculator 110 uses corporate data 104 and store data 108a-c to determine staffing levels for each retail store 106a-106c. A staffing adjuster 112 adjusts the staffing levels according to store prioritization. Payroll plans 114 are generated and distributed to the retail stores 106.

Users at a retail headquarters 102 determine corporate data 104 relating to staffing for some or all affiliated retail stores, including the retail stores 106a-106c. The corporate data 104 includes strategic staffing parameters, for example, intentional overstaffing of stores during a certain time period or in a certain key geographic region, staffing for aggregate margin enhancement, or staffing for enhancement of productivity of one or more workflow drivers.

Store data 108 is generated and collected from the stores 106. In this example, the retail stores 106a-106c comprise a sales district and have adjoining and/or overlapping markets. The store data 108 includes historical records of staffing data, including operational factors for the store and staffing levels. Example operational factors include, but are not limited to, time-to-unload, time-to-stock, product throughput, item pulls, items per pull, back stows, signs, trailers, abandons, price changes, sales mix, transition hours, weekly sales history, ad mapping, cluster model data, and mid-month guidance thresholds.

The multi-store staffing calculator 110 receives the corporate data 104 and the store data 108. An exponential smoothing calculation, such as one involving the Holt-Winters algorithm, is performed on historical information in the corporate data 104 and the store data 108. In some implementations, the exponential smoothing calculation generalizes the historical information or generates a forecast of future measurements based on the historical information. For example, the exponential smoothing calculation considers recentness, trend, and fluctuations in the historical information.

The foregoing is accomplished, in one embodiment, by application of the following Holt-Winters exponential smoothing algorithm, which is publicly available at www.sageworksanalyst.com:

Variables
alpha: weight to place on previously predicted values (0<alpha<1)
(1-alpha): weight to place on the most recent actual value
beta: weight to place on historical trend (0<beta<1)
(1-beta): weight to place on most recent trend
tw: weight to place on the overall trend
aₜ=weighted average component of the forecast at time t for the period t+1
tₜ=trend component of the forecast at time t for the period t+1 (expected increase from time t to time t+1)
fₜ=aₜ+(tₜ*tw)=forecast at time t for the period t+1
Xₜ=actual value at time t

Calculation
Step 1: Initialize a, t, and f using oldest historical data

a₂=X₂

t₂=X₂−X₁

f₂=a₂+(t₂*tw)
Step 2: Iteratively calculate a, t, and f

a₃=alpha*f₂+(1-alpha)*X₃

t₃=beta*t₂+(1-beta)*(a₃−a₂)

f₃=a₃+(t₃*tw)

aₙ=alpha*fₙ₋₁+(1-alpha)*Xₙ

tₙ=beta*tₙ₋₁+(1-beta)*(aₙ−aₙ₋₁)

fₙ=aₙ+(tₙ*tw)

As will be appreciated by those skilled in the art, the foregoing algorithm can be applied to the various smoothing calculations discussed herein.

The multi-store staffing calculator 110 uses the results of the exponential smoothing calculation to project retail activity levels at the stores 106, for example, for the next year. The multi-store staffing calculator 110 assigns staffing levels to the stores 106 to meet the staffing requirements of the projected retail activities according to the strategic staffing parameters. In this example, the stores 106 are minimally staffed, with excess available staffing recorded but unassigned.

The staffing adjuster 112 receives the assigned staffing levels and the available staffing from the multi-store staffing calculator 110. The retail stores 106a-106c are prioritized by the multi-store staffing calculator 110. Two of the criteria used in the prioritization are sales volume (e.g., number of items sold) and productivity (e.g., work accomplished per staffing time unit.) Based on the associated prioritization, the staffing levels for each store 106a-106c are increased, reduced, or finalized at the pre-adjusted level.

The staffing levels for each retail store 106a-106c are assigned to workcenters (e.g., departments, job categories) within the retail stores 106a-106c. In some examples, all of the staffing assigned to a store is assigned to workcenters, for example, to ensure efficiency. In some examples, a portion of the staffing assigned to a store is left unassigned, for example, to ensure flexibility.

In some embodiments, the multi-store staffing calculator 110 uses corporate data 104 and store data 108 to predict an hourly payroll that each store receives each week or month, for example, by applying statistical modeling techniques suitably modified to adhere to a particular store's current and/or future operating principles and policies. For example, the multi-store staffing calculator 110 identifies key drivers for payroll in stores using a combination of hypothesis testing on historical data and knowledge of business processes. In addition to driver identification, the multi-store staffing calculator 110 implements a combination of dynamic time series models (e.g., Holt-Winters, ARIMA, Step wise autoregressive, etc.) and applies such models to historical data residing in various data warehouses. In some example calculations, the multi-store staffing calculator 110 performs the above analysis while accounting for internal store events including but not limited to circulars, promotions and price cut events.

A number of analysis models can be implemented using driver information. The models are generally categorized into (a) Sales Anchored Models (SAM) or (b) Historical Actual Models (HAM). Sales Anchored Models are represented in one example as:

Payroll Driverᵢ(t)=f{(Payroll Driverᵢ(t−1, t−2, t−3, . . . ), Sales (t−1,t−2, t−3, . . . )}

Historical Actual Models are represented in one example as:

Payroll Driverᵢ(t)=f{(Payroll Driverᵢ(t−1, t−2, t−3, . . . )}

where i is the payroll driver that is being forecasted and t is the current time period for which the driver is being forecasted.

Various SAM and HAM analysis models are used to analyze driver information and predict optimization data. For example, SAM models include, but are not limited to (i) regression with sales, (ii) autoregressive error with sales, and (iii) ARIMAX. HAM models include, but are not limited to (i) decomposition models, (ii) ARIMA (iii) autoregressive error models, and (iv) Holt-Winters.

Example mathematical representations of the models tested are shown below:

Regression with Sales uses Historical values of Payroll Driver i that are assumed to be related to Sales as in the following equation:

Payroll Driverᵢ(t)=α+β*Sales(t)+error

where estimators of α and β are found by minimizing the error sum of squares, Σe², or in other words, setting the first order differential with respect to α and β to 0.

Autoregressive error with sales represents a model which identifies correlation between past values of the error term, eₜ, eₜ₋₁, eₜ₋₂ and predicts future values of the payroll driver based on historical values of the payroll driver itself and sales after taking into account the dependencies of the error values with each other.

Payroll Driverᵢ(t)=α+β*t+ρ*Sales (t)+Error; and

Error (t)=χ*Error (t−1)+ε(t)

where ε(t) is normally and independently distributed with 0 mean and variance σ².

ARIMAX is an extension of the Autoregressive Integrated Moving Average (ARIMA) modeling process. While ARIMA considers historical values of the driver itself and the error, ARIMAX, in addition, considers historical values of sales as well. For examples of a mathematical expression for ARIMAX, please refer to the section below on ARIMA.

Decomposition Models include models based on the assumption that any time series could be expressed in a linear or multiplicative form as follows:

Payroll Driverᵢ(t)=Trend+Seasonality+Irregular

Payroll Driverᵢ(t)=Trend×Seasonality×Irregular

In a multiplicative model, decomposition is performed using (a) a 12×2 Moving Average to isolate trend, (b) Payroll Driver (t)/Trend (t) to isolate Seasonality and Irregular Component, (c) an average value across the same weeks to isolate seasonality, and (d) Payroll Driver (t)/{Trend (t)×Seasonality (t)} to isolate irregular component

ARIMA: The mathematical representation of ARIMA (1, 1, 1) is as follows:

Payroll Driverᵢ(t)=α+Payroll Driverᵢ(t−1)+β*Payroll Driverᵢ(t−2)+τ*{Payroll Driverᵢ(t−1)−Payroll Driverᵢ(t−2)}−ψ*error (t−1)

Autoregressive error represents a model which identifies correlation between past values of the error term, eₜ, eₜ₋₁, eₜ₋₂ and predicts future values of the payroll driver based on historical values of the payroll driver itself as well as the dependencies of the error values with each other.

Payroll Driverᵢ(t)=α+β*t+error;

Error (t)=χ*Error (t−1)+ε(t)

where ε(t) is normally and independently distributed with 0 mean and variance σ².

Holt-Winters uses a method to predict future values based on historical data after taking into account level, trend, and seasonality. The model takes the following mathematical form:

Payroll Driverᵢ(t)=(α+β₁t+β₂t²+ . . . βₙtⁿ) σ(t)+εₜ

where α and βᵢ are the trend parameters, σ(t) represents the seasonal parameter for the season corresponding to time t, and εₜ represents a Random Error component.

Each model is tested out for all drivers and dynamically chosen based on the Mean Absolute Percent Error or MAPE. In addition to the standard mathematical forms mentioned above, several transformations including (a) square (b) logarithmic, and (c) logarithmic square are also tested before selecting the final model. The models are developed using standard procedures in SAS (i.e., procedure forecast, procedure arima, and procedure reg[gression]).

Upon determining key drivers for payroll in stores and modeling data, the multi-store staffing calculator 110 performs a series of stochastic, segmentation and optimization techniques to generate payroll hours at a store level. For example, the multi-store staffing calculator 110 (or another module) uses a stochastic regression model to dynamically identify drivers for each store to predict hours based on the store performance. The hours generated through this process are then compared with the performance standards at a peer level identified in one example through CHAID (Chi Square Automatic Interaction Detector) which also accounts for operating characteristics unique to particular stores. The output of the CHAID is used as an initial payroll hour estimate. The estimate of initial payroll hours is inputted into an optimization algorithm which employs both linear and non-linear programming routines. A value (or set of values) representing final optimized hours is determined and provided as output.

CHAID includes forming Peer Groups to standardize the process of generating need hours for the stores by taking into account store historical productivity performance and a combination of non-controllable factors, herein referred to as productivity drivers that are known to impact a stores' performance. The productivity drivers are unique to each store and are chosen based on a combination of business inputs and various tests for statistical significance (e.g., t and chi-square). The basic premise of the peer group is to group stores having similar attributes and that drive similar sales productivity in a manner that the variation within a peer group is lowest and that across the peer group is highest.

CHAID modeling is an exploratory data analysis method used to study the relationships between a dependent measure (e.g., Pre-Unique sales productivity) and a large series of possible predictor variables (e.g., productivity drivers) that themselves may interact. The dependent measure may be a qualitative (nominal or ordinal) one or a quantitative indicator. For qualitative variables (e.g., Prototype, Volume Class, Unique Backroom), a series of chi-square analyses are conducted between the dependent and predictor variables. For quantitative variables, analysis of variance methods are used where intervals (i.e., splits) are determined optimally for the independent variables so as to maximize the ability to explain a dependent measure in terms of variance components.

Each store is mapped to a peer group using an SAS code as below developed from the English Rules in SAS E-Miner. The final decision rule is based after applying different pruning and branch and bound techniques at different significance levels. The following example code represents peer groups for D-Volume GM stores.

```
IF Cnt_Rtrns < 27356.5 AND Vol = ‘D’ THEN PEERGRP = ‘D1’;
ELSE IF Home_P < 0.1766319652 AND Cnt_Rtrns >= 27356.5 AND
Vol = ‘D’ THEN
  PEERGRP = ‘D2’;
ELSE IF (0.1766319652 <= Home_P < 0.2307683875) AND
Cnt_Rtrns >= 27356.5
  AND Vol = ‘D’ THEN PEERGRP = ‘D3’;
ELSE IF Home_P >= 0.2307683875 AND Cnt_Rtrns >= 27356.5 AND
Vol = ‘D’ THEN
  PEERGRP = ‘D4’;
```

An Ordinary Least Square (OLS) Regression Model is used for each peer group to identify the need hours for stores belonging to a particular peer group. The coefficients are found by minimizing the error sum of squares. The coefficients may vary across peer groups to reflect the additional need arising out of unique store attributes. For example, an example Need Hours equation for a peer group A1 is represented as:

Need Hours=α+β*Payroll Driver 1+χ*Payroll Driver 2+δ*Payroll Driver 3

An example Need Hours equation for a peer group A2 is represented as:

Need Hours=α₁+β₁*Payroll Driver 1+χ₁*Payroll Driver 2+δ₁*Payroll Driver 3

The optimization algorithms discussed above generally represent an objective function and a set of constraints. The objective function is solved as a linear programming problem by setting all the constraints to 0 and identifying a set of basic feasible solutions satisfying the constraints. In some embodiments, the object function is to minimize an average weighted tasking of stores using the following equation:

Min Σw(i, j)*p (i, k)*s (i, k)*t (i,j,k)²

where (i, j) denotes the Prototype and Productivity Rank and (i, k) denotes the Prototype and Volume Class

In one example, the constraints include a corporate goal of ΣHₜ=H, where Hₜ represents hours allocated to store t and H represents the corporate tie to hours. The constraints further include a Minimum Hour Need of Hₜ>=h for all t, where Hₜ=hours allocated to store t and h represents the minimum hours. “T” indicates the task assigned to a particular store.

At a first level, the constraints are represented as T (G, 1)>T (G, 2)>T (G, 3)> . . . >T (G, n), T (S, 1)>T (S, 2)>T (S, 3)> . . . >T (S, p), T (P, 1)>T (P, 2)>T (P, 3)> . . . >T (P, r) . . . . At a second level, the constraints are represented as T (G, A)>T (P, A)>T (S,A), T (G, B)>T (P, B)>T (S, B) . . . where (G, 1) indicates Vol A-AAA+GM store with the highest difference between last year for unique sales productivity and the average peer store productivity. The (G, A,1) constraint can alternatively indicate 10 Vol A-AAA+GM stores with the highest difference between last year for unique sales productivity and the average peer store productivity.

The constraints can be used to assign tasking rank to a particular store based on Prototype, Volume Class and a difference in last year for unique sales productivity from the average “peer store,” for example. Stores can be grouped together based on the spread of the productivity rank or a percent difference from the average peer store.

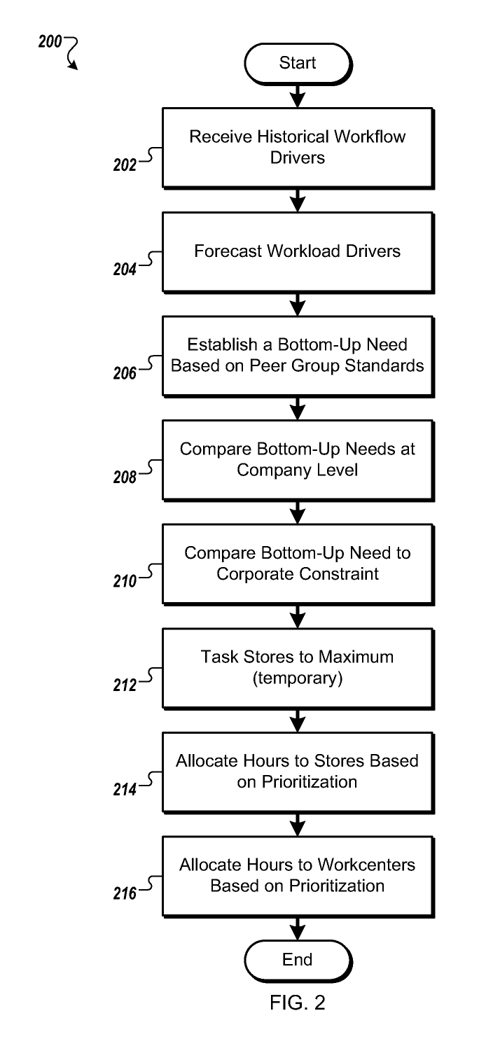

FIG. 2 is a flowchart showing an example process 200 for allocating staffing levels to stores and workcenters. The process 200 is performed by, for example, a computer system executing a multi-store staffing calculator and a staffing adjuster.

Historical workflow drivers are received (202). For example, historical workflow data representing workflow drivers (e.g., productivity values and sales values) are received for each store. The historical workflow data generally includes numerical values corresponding to retail activity performed by retail employees.

In some embodiments, the workflow drivers are employee and retail measurements for a peer group of stores for a preceding time period, such as the preceding year. Incremental changes in workload are considered and, in some examples, associated with retail events (e.g., the holiday sales season, sudden economic changes.)

Workflow drivers are forecasted (204) for an upcoming time period such as the upcoming year. The forecast is calculated with an exponential smoothing calculation projected for future values. The exponential smoothing calculation includes at least an exponent for weighing events based on recentness, an exponent to account for trend, and an exponent to adjust for seasonal fluctuations. In some examples, the forecast takes into account other data that affects the workflow drivers, such as external economic trends, new product launches, or planned renovations of a retail store.

A set of bottom-up needs are established (206) based on workload standards created for the peer group of stores. The bottom-up needs include information that defines staffing needs to meet the projected workload drivers. The standards are created to manage the peer group and bring the productivity of each store in line with the rest of the peer group, in some examples, at the workcenter level.

In a retail company with multiple peer groups, the workload standards optionally vary from peer group to peer group and a company-wide set of needs are determined for the company. The established needs for a peer group are compared (208) to the company-wide set of needs. This comparison provides, for example, a comparison of each peer group to the company as a whole, such as to aid in identifying peer-groups operating at above or below the company average.

The established needs for a peer group are compared (210) with corporate or strategic constraints. This comparison provides, for example, a measurement between the minimum forecasted needs and the additional staffing required to meet the corporate goals described in the constraints. The corporate constraints include strategic overstaffing or understaffing for some times (e.g., holidays, sales events), geographic regions, or activities. In one example, strategic constraints are used to enhance staffing in a subset of stores of a retail enterprise located in a particular geographic region. For example, staffing is strategically increased during the holiday season in a city with a high population of people. In some embodiments, staffing is optimized to reduce staff levels assigned to a specific store based on the store having i) a low productivity level and ii) a high sales volume. Alternatively, staffing is optimized to reduce staff levels assigned to a specific store based on the store having i) a high productivity level and ii) a low sales volume.

The stores in the peer group are tasked (212) to maximum staffing capabilities, that is, with the minimum staffing necessary to meet the bottom-up needs and corporate constraints. Additional staffing hours are allocated (214) to, or removed from, some or all of the stores in the peer group based on a prioritization of each store in the peer group. Staffing hours assigned to each store are further allocated (216) to workcenters within each of the stores. In some examples, the distribution of staffing hours by workcenter is constant for each store in the peer group. In some other examples, the distribution of staffing hours by workcenter varies from store to store, for example, in correlation with the workflow drivers of each store.

Although a particular number, order, and type of steps are displayed in this example, it will be understood that different numbers, orders, and types of steps are possible. In another example, additional staffing hours are allocated (214) evenly to each store in a peer group.

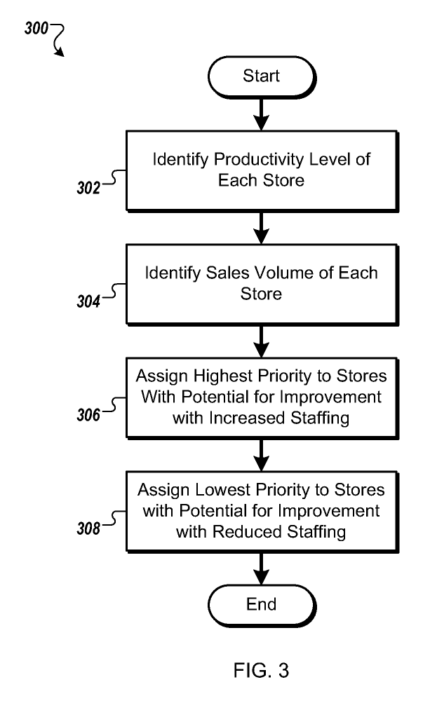

FIG. 3 is a flowchart showing an example process 300 for assigning prioritization levels. The process 300 is performed by, for example, a computer system tasked with executing the step 214 (FIG. 2).

Productivity levels of stores in a peer group of stores are identified (302). For example, stores record production data such as on-the-clock employees, logistic measurements, and retail events. The stores in the peer group are ranked (e.g., placed in an order) or categorized (e.g., as having high productivity or low productivity).

Sales volumes of stores in a peer group of stores are identified (304). For example, store data recording retail sales is examined to determine a number of sales, price volume of sales, and/or a number of items sold per sale. The stores in the peer group are again ranked or categorized. The steps 302 and 304 result in a two dimensional ranking or categorization of the stores in the peer group. For some example peer groups, productivity level and sales volume are independent factors and any combination of productivity level and sales volume are possible.

A high staffing priority value is assigned (306) to stores that have potential for improvement based on increased staffing levels. Assigning a particular priority value is based on a productivity value and/or a sales volume value for a given store. In some examples, a store with high productivity and low sales is identified as having the potential to increase sales and maintain productivity if the staffing levels are increased.

A low staffing priority is assigned (308) to stores that have potential for improvement based on decreased staffing levels. For these stores, productivity is not expected to increase with higher staffing levels and a slight reduction in staffing potentially has a significant impact on factors such as overall store profitability.

Although a particular number, order, and type of steps are displayed in this example, it will be understood that different numbers, orders, and types of steps are possible. In another example, a store with low productivity and a low sales volume is identified as possibly under-serving a market that has a demand for the store's products. In this example, a high staffing priority is temporarily assigned (306) to the store and results will indicate whether the market supports an expansion of the store.

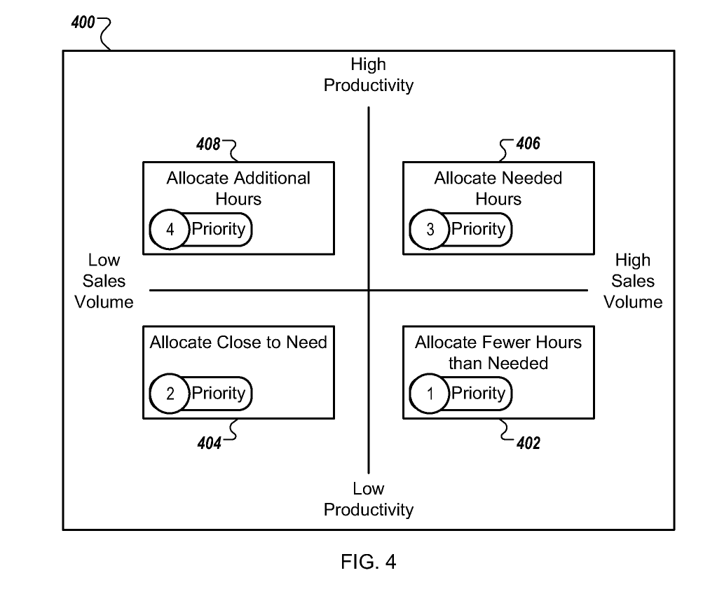

FIG. 4 is a chart 400 of an example prioritization scheme. The prioritization scheme is suitable for use with, for example, a retail chain selling a wide variety of products in a wide variety of markets. The retail chain, in this example, includes many regional districts, each regional district having a staffing budget to be distributed to the stores within the district. The example prioritization scheme shown is used, for example, by a computer system executing the process 300.

Stores are indexed according to productivity and sales volume. In the illustrated prioritization scheme, productivity is measured on the horizontal axis and sales volume is measured on the vertical axis. The indexing creates four regions:

A low productivity/high sales region 402

A low productivity/low sales region 404

A high sales/high productivity region 406

A low sales/high productivity region 408

All stores have an associated minimum staffing requirement determined by forecasted workflow drivers and strategic staffing parameters. Increasing or decreasing the associated staffing encourages increased efficiency by changing staffing in light of current productivity and sales volume.

Stores identified in the low productivity/high sales region 402 are assigned a priority level of 1, indicating that fewer hours should be assigned than forecasted. Stores in the region 402 show the greatest potential to improve productivity by driving productivity and maintaining sales. In other words, a lower priority level (e.g., priority level 1 is lower than priority level 2) here indicates that the store is receiving relatively less staffing resources.

Stores identified in the low productivity/low sales region 404 are assigned a priority level of 2, indicating that staffing should be allocated close to, but slightly below, forecasted need. Achieving productivity improvements in stores in the region 404 is difficult without impacting future sales and the assigned priority level drives productivity while conserving sales.

Stores in the high sales/high productivity region 406 are assigned a priority level of 3, indicating that staffing levels should be allocated at forecasted need. This allocation maintains productivity and sales, but in the case of needed cut downs, allows for a reduction in staffing.

Stores in the low sales/high productivity region 408 are assigned a priority level of 4, indicating that staffing levels should exceed forecasted need. This allocation improves productivity and drives sales. For these stores, sales have been negatively impacted to maintain high productivity. Priority level 4 is the highest priority level assigned in this example, and here indicates that the store is receiving relatively more staffing resources.

In some examples, stores are assigned ratings based on their productivity and sales volume, without assigning the stores to categories, and the stores are plotted on the chart 400. In these examples, the difference between forecasted staffing needs and assigned staffing levels is determined in part by the distance between the plot for each store and the intersection of the productivity and sales volume axis.

In some examples, different allocation strategies are associated with some or all of the regions 402-408. In one such example, stores in the low productivity/low sales region 404 are assigned a priority level 1, reflecting that the store is designated to close within the forecast time frame and less staffing will be required during disposition of the store.

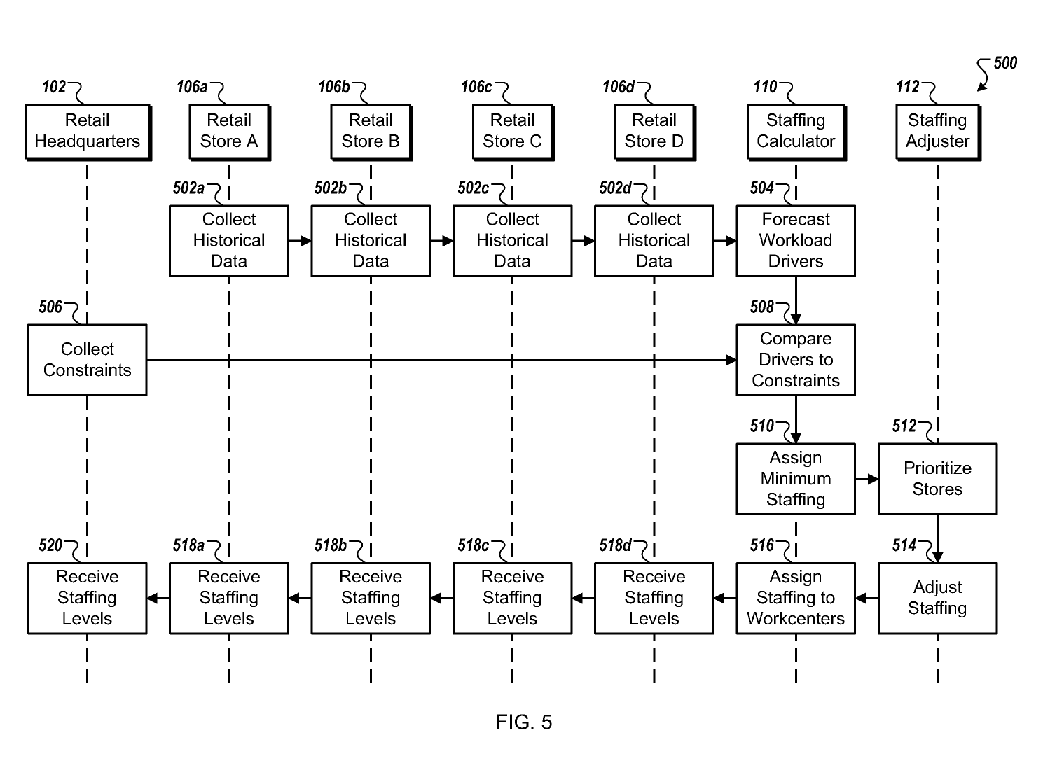

FIG. 5 is a swimlane diagram showing an example process 500 for assigning staffing levels. In the process 500, a retail chain enterprise software system is used to plan staffing levels for a group of retail stores. This example involves some components described above with regard to FIG. 1 and also an additional retail store 106d. Each of the retail stores 106a-106d collects (502) historical data. The historical data includes sales, performance, and employment data that is routinely and automatically collected during the day-to-day operations of the retail stores 106.

The multi-store staffing calculator 110, which in this example includes an application running on a server residing in the building of the retail headquarters 102, receives the historical data. The multi-store staffing calculator 110 forecasts (504) workload drivers for each of the stores for the next fiscal year. The multi-store staffing calculator 110, in this example, executes instructions implementing the Holt-Winters algorithm and uses the resulting projection in the forecast.

The retail headquarters 102 collects (506) constraints specifying situations that require additional staffing beyond the staffing indicated by previous store activity. The multi-store staffing calculator 110 compares (508) the forecast workload drivers to the constraints, selecting the maximum staffing requirement for each time unit (e.g., day, pay period.) The multi-store staffing calculator 110 assigns (510) minimum staffing levels to each of the stores to meet the selected staffing requirements. A pool of unassigned staffing is determined.

The staffing adjuster 112 which, in this example, also includes an application running on a server residing in the building of the retail headquarters 102, prioritizes (512) the retail stores 106a-106d. In some implementations, the prioritizations are determined to most efficiently assign available staffing, to increase productivity and/or sales volume at the retail stores 106a-106d, and to adjust the performance of each of the retail stores 106a-106d to be more in line with the average performance of all of the retail stores 106a-106d. The staffing adjuster 112 adjusts (514) the staffing levels of one or more of the retail stores 106a-106d. For example, the staffing adjuster 112 increases some staffing levels, decreases some staffing levels, and leaves some staffing levels unadjusted.

The multi-store staffing calculator 110 assigns (516) staffing levels to each of the workcenters within each of the retail stores 106a-106d. In this example, the staffing requirements of each workcenter are predetermined as a percentage of the staffing available to the associated retail store 106.

Each of the retail stores 106a-106d receives (518a-d) its associated staffing levels for the coming fiscal year and all staffing levels are received (520) by the retail headquarters 102. In this example, a report for each of the retail stores 106a-106d is generated and printed. The reports are bound, packaged, and shipped to the stores via parcel mail. The retail headquarters 102 stores all staffing levels in a long term data storage archive, to be accessed when needed.

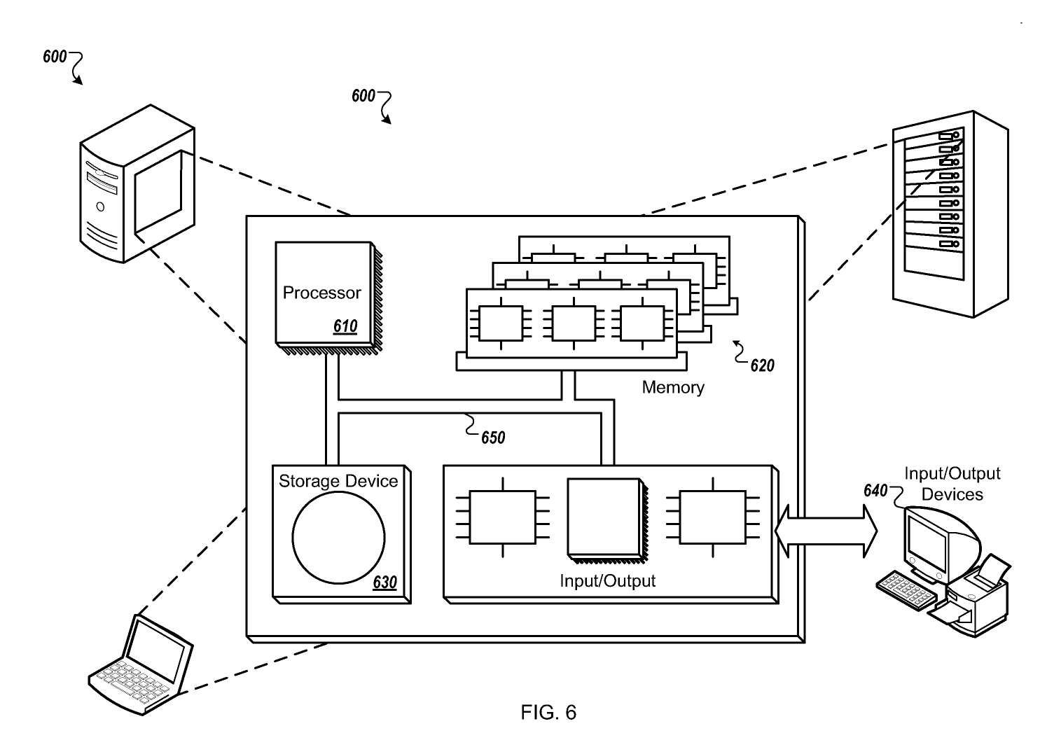

FIG. 6 is a block diagram of a computing system. Optionally used in FIG. 6 is a schematic diagram of a generic computer system 600. The system 600 is optionally used for the operations described in association with any of the computer-implemented methods described previously, according to one implementation. The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 is optionally a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

In some examples, the features described are implemented in digital electronic circuitry, or in computer hardware, firmware, software, or in combinations of them. The apparatus is optionally implemented in a computer program product tangibly embodied in an information carrier, e.g., in a machine-readable storage device or in a propagated signal, for execution by a programmable processor; and method steps are performed by a programmable processor executing a program of instructions to perform functions of the described implementations by operating on input data and generating output. The described features are optionally implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that are optionally used, directly or indirectly, in a computer to perform a certain activity or bring about a certain result. A computer program is optionally written in any form of programming language, including compiled or interpreted languages, and it is deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory are optionally supplemented by, or incorporated in, ASICs (application-specific integrated circuits).

To provide for interaction with a user, the features in some instances are implemented on a computer having a display device such as a CRT (cathode ray tube) or LCD (liquid crystal display) monitor for displaying information to the user and a keyboard and a pointing device such as a mouse or a trackball by which the user provides input to the computer.

The features are optionally implemented in a computer system that includes a back-end component, such as a data server, or that includes a middleware component, such as an application server or an Internet server, or that includes a front-end component, such as a client computer having a graphical user interface or an Internet browser, or any combination of them. The components of the system are connected by any form or medium of digital data communication such as a communication network. Examples of communication networks include, e.g., a LAN, a WAN, and the computers and networks forming the Internet.

The computer system optionally includes clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications are optionally made without departing from the spirit and scope of this disclosure. Accordingly, other embodiments are within the scope of the following claims.

What is claimed is:

1. A method for optimizing staff scheduling comprising:
receiving in a computer system historical operational workflow data for a plurality of retail stores, the historical operational workflow data including numerical values corresponding to retail activities performed by retail employees at the plurality of retail stores;
receiving in the computer system, for the plurality of retail stores, at least one discretionary strategic constraint impacting optimal retail staffing levels, the at least one strategic constraint being independent of historical operational workflow data;
determining, using the computer system, optimized staffing specifications for the plurality of retail stores, said determining including applying an exponential smoothing calculation to historical workflow drivers and being based at least in part on the at least one strategic constraint; and
assigning, to each of the stores, staffing based at least in part on the optimized staffing specifications.

2. The method of claim 1, wherein the strategic constraint enhances staffing in a predetermined time window associated with a holiday.

3. The method of claim 1, wherein the strategic constraint enhances staffing in a subset of stores of a retail enterprise that fall within a predetermined geographic region.

4. The method of claim 1, wherein the strategic constraint is selected to increase aggregate store margin.

5. The method of claim 1, wherein receiving the historical operational workflow data includes receiving, for each store in the plurality of stores, a productivity value and a sales volume value, the method further comprising:
determining a priority value for each store in the plurality of stores based at least on the sales volume and productivity values; and
wherein determining the optimized staffing specifications includes changing a previous employee staffing resource level for at least one store in the plurality of stores according to the priority value for the store.

6. The method of claim 5, wherein the optimized staffing specifications reduce a staffing level assigned to a store with i) a low productivity level and ii) a high sales volume.

7. The method of claim 5, wherein the optimized staffing specifications reduce a staffing level assigned to a store with i) a high productivity level and ii) a low sales volume.

8. The method of claim 1, wherein determining comprises (i) weighing data associated with retail events based on recentness, (ii) accounting for at least one retail trend, and (iii) adjusting for seasonal fluctuations.

9. The method of claim 1, wherein the historical operational workflow data includes at least two data items selected from the group consisting of time-to-unload, time-to-stock, and product throughput.

10. A method comprising:
receiving an electronic record of historical workflow data for a plurality of retail stores, the historical workflow data having numerical values corresponding to retail activity performed by retail employees;
receiving in electronic form for the plurality of retail stores a strategic rule set that enhances certain staffing levels based on factors independent of historical workflow data;
determining, using a computer system, master staffing parameters for the plurality of retail stores, said determining including applying an exponential smoothing calculation to the historical workflow data that (i) weighs events based on recentness, (ii) accounts for trend, and (iii) adjusts for seasonal fluctuations and further including applying the strategic rule set;
assigning, to each of the stores, an employee staffing resource level according to the master staffing parameters; and
outputting from the computer system employee staffing resource levels for receipt by the plurality of retail stores.

11. The method of claim 10, wherein the historical workflow data includes at least three members of the group consisting of time to unload, time to stock, product throughput, pulls, items per pull, back stows, signs, trailers, abandons, price changes, sales mix, transition hours, weekly sales history, ad mapping, cluster model data, and mid-month guidance threshold.

12. The method of claim 10, wherein the historical workflow data includes productivity values and sales volume values and wherein the method further comprises:
determining a priority value for each store in the plurality of stores based at least on the sales volume and productivity values;
wherein assigning the employee staffing resource levels includes changing a previous employee staffing resource level for at least one store in the plurality of stores according to the priority value for the store.

13. The method of claim 10, wherein the employee staffing resource level assigned to a store with low productivity level and high sales volume reduces a current employee staffing resource level for the store.

14. The method of claim 10, the method further comprising assigning, based on the employee staffing resource levels assigned to each of the plurality of retail stores, employee staffing resource levels to a plurality of workcenters of each retail store.

15. The method of claim 10, wherein the strategic rule set enhances staffing in a predetermined time window associated with a holiday.

16. The method of claim 10, wherein the strategic rule set enhances staffing in a subset of stores of a retail enterprise that fall within a predetermined geographic region.

17. The method of claim 10, wherein the strategic rule set is selected to increase aggregate store margin.

18. A computer program product tangibly embodied in a computer-readable storage medium and comprising instructions that, when executed by a processor, perform a method for optimizing employee staffing levels, the method comprising:
receiving, in a computer system, a record of historical workflow drivers for a plurality of retail stores, the workflow drivers having numerical values corresponding to retail activity performed by retail employees;
receiving, in the computer system, for the plurality of retail stores, a strategic retail constraint independent of the historical workflow drivers and indicating a need for extra staffing according to a first variable;
determining, using the computer system, expected workflow drivers for the plurality of retail stores, including applying an exponential smoothing calculation to the historical workflow drivers;
determining, for each of the stores, an optimized employee staffing resource level to meet staffing requirements of the expected workflow drivers and further to meet the strategic retail constraint; and
outputting from the computer system employee staffing resource levels for receipt by the plurality of retail stores.

19. The computer program product of claim 18, wherein the strategic retail constraint enhances staffing in a predetermined time window associated with a holiday.

20. The computer program product of claim 18, wherein the strategic retail constraint enhances staffing in a subset of stores of a retail enterprise that fall within a predetermined geographic region.

21. The computer program product of claim 18, wherein strategic retail constraint is selected to increase aggregate store margin.

22. The computer program product of claim 18, wherein determining expected workflow drivers includes (i) weighing events based on recentness, (ii) accounting for retail trends, and (iii) adjusting for seasonal fluctuations.
